(19) United States
(12) Patent Application Publication
(10) Pub. No.: US 2002/0031129 A1
(43) Pub. Date: Mar. 14, 2002

(54) Method of managing voice buffers in dynamic bandwidth circuit emulation services

(76) Inventors: Dawn Finn, Kanata (CA); George Jeffrey, Nepean (CA)

Correspondence Address: MARKS AND CLERK, P O BOX 957, STATION B, 55 METCALFE STREET, SUITE 1380, OTTAWA, ON, K1P5S7, CA

(21) Appl. No.: 09/948,651

(22) Filed: Sep. 10, 2001

Related U.S. Application Data
(60) Provisional application No. 60/236,162, filed on Sep. 29, 2000.

(30) Foreign Application Priority Data
Sep. 13, 2000 (GB) 0022384.2

(51) Int. Cl. H04L 12/56

(52) U.S. Cl. 370/395.41; 370/412

(57) ABSTRACT

In a method of managing buffers in a SAR (Segmentation and Reassembly) device operating in DBCES (Dynamic Bandwidth Circuit Emulation Service) mode, first an active channel buffer limit is determined. This is dependent on the number of active channels in the virtual circuit. Next, the amount of buffering for each active channel is set equal to the CDV (Cell Delay Variation) plus the active channel buffer limit. This prevents underruns over overruns from occurring when the number of active channels suddenly changes.

### CROSS-REFERENCE TO RELATED APPLICATIONS

This application claims priority under 35 USC 119(e) from U.S. provisional application No. 60/236,162 filed on Sep. 29, 2000.

### BACKGROUND OF THE INVENTION

1. Field of the Invention

This invention relates to telecommunications, and more particularly to Dynamic Bandwidth Circuit Emulation Services (DBCES) in a cell-relay network, such as ATM.

2. Description of the Related Art

ATM (Asynchronous Transfer Mode) is a service that carries data in small fixed size packets or cells over a packet switched network. The cells are statistically multiplexed on fixed physical links between network nodes and establish virtual circuits over the network between endpoints. ATM includes a number of specifications of which AAL1 (ATM Adaptation Layer 1) establishes a standard for carrying time sensitive data, such as voice or video, over the virtual circuits between the endpoints. This is known as circuit emulation (CES) because it provides a number of voice channels that to the user appear similar, for example, to time division multiplexed channels.

DBCES is a mode of dynamic bandwidth utilization in an ATM network based on detecting which time slots of a given TDM trunk are active and which are inactive. When an inactive state is detected in a specific time slot, the time slot is dropped from the next ATM structure and the bandwidth it was using may be reutilized for other services. DBCES is described in detail in ATM Forum specification: af-vtoa-0085.000 (July 1997).

Devices known as SARs (Segmentation and Reassembly) devices convert incoming data to cells and vice versa. SARs include buffers for storing the cells to be processed.

When operating in DBCES (Dynamic Bandwidth Circuit Emulation Services) mode, if the number of voice channels carried by the AAL1 cell stream changes, the rate at which the cells arrive at the receiver changes. This change in arrival rate can cause an underrun or overrun in the voice buffer at the receiver which receives the incoming cells unless special provisions are made.

In order to address this problem, it has been proposed to add extra buffer allocation to prevent overruns, and to insert extra delay in the buffer to prevent underruns. Alternatively, another solution is to start the buffer with a specific number of voice channels active to establish adequate buffer fill, but the buffer may not recover automatically from slip errors.

Finally, another solution is just to let the underruns and overruns occur; however, that would cause the receivers to receive incorrect data, which translates to clicking sounds in the received audio.

### SUMMARY OF THE INVENTION

In a broad aspect the invention provides a method of managing buffers in a SAR (Segmentation and Reassembly) device operating in DBCES (Dynamic Bandwidth Circuit Emulation Service) mode, comprising determining an active channel buffer limit for a virtual circuit dependent on the number of active channels; and setting the amount of buffering for each active channel equal to the CDV (Cell Delay Variation) plus the active channel buffer limit.

The amount of buffering is typically represented by the distance between the write-pointer and read-pointer for the circular buffers. In accordance with the invention, for any current value of active voice channels, N, a defined minimum number of active voice channels, MIN, and a desired cell delay variation tolerance, CDV, a desired write-pointer spacing (slip-pointer) from the read-pointer is calculated. On start-up or on an error (i.e., underrun or overrun), this desired spacing is used to create a new value for the write-pointer.

Allowing various definitions of MIN allows the user of the system to trade-off delay in the buffer for bandwidth in the cell stream. Recalculating the desired spacing when N changes lets the buffer handle any number of voice channels down to MIN. Recovery from errors is performed automatically (without user CPU intervention) through the use of correct buffer spacing. The cell stream may be started with any initial value, N, of active voice channels.

The inclusion of the cell delay variation (CDV) in the calculation means that any cell delay variation in the received cell stream will not cause slip errors (i.e., underruns or overruns).

Typically, the spacing is defined such that write-pointer read-pointer+CDV+(47/MIN)−(47/N), where 47 is used because each in ATM AAL1 cell contains approximately 47 bytes of voice data.

### BRIEF DESCRIPTION OF THE DRAWINGS

The invention will now be described in more detail, by way of example only, with reference to the accompanying drawings, in which:—

FIGS. 1a and 1b are block diagrams showing the circular buffers in SARs for both SDT and DBCES modes of operation of a SAR; and

FIG. 2 is a block diagram showing the reassembly control structure for a SAR in a preferred implementation.

### DETAILED DESCRIPTION OF THE PREFERRED EMBODIMENTS

Structured Data Transfer mode (SDT) is an AAL1 data transfer mode in which data is first structured into blocks which are then segmented into cells for transfer.

In a typical application, TDM data is transferred over an ATM virtual circuit between a transmit or segmentation device (TX_SAR) and a receive or reassembly device (RX_SAR), which as noted above convert data between ATM cells and vice versa. The virtual circuit carries a number of channels emulating a TDM service.

The SDT RX_SAR is responsible for writing data from received cells into Reassembly Circular Buffers, while the TDM module reads the data from the buffers and outputs it as TDM channels. However, some buffering control is required because the SDT RX_SAR and the TDM operate at different clock rates (the data is placed into the buffers based on the cell arrival rate (which varies) while the data is read from the buffers at a constant rate determined by the TDM output clock rate (e.g., 2.048 MHz).

In the SDT and DBCES modes of operation, one of the major tasks of the SDT RX_SAR is to ensure that no underruns or overruns occur between the SDT RX_SAR and a TDM module converting the data to time division multiplexed channels. An underrun occurs when there is insufficient data in the buffer to supply the TDM module at the TDM rate. An overrun occurs when the buffer overflows due to the cells arriving faster than the data is read out by the TDM module.

The SDT RX_SAR is responsible for maintaining a relationship between the SDT RX_SAR's write-pointer and the TDM module's read-pointer. This control is provided by a routine which, each time that the SDT RX_SAR is about to write to the circular buffer, determines the distance between the write-pointer and the read-pointer. Normally, each write occurs where the previous write ended, and the write-pointer simply advances as the bytes are written. However, on start-up, or when the SDT RX_SAR's algorithm has decided that a slip error (i.e., overrun or underrun) has occurred, or when changing from zero active channels to at least one active channel, the SDT RX_SAR uses an internally-calculated write-pointer value as the correct write-pointer value.

In these cases, regardless of the original write-pointer value, the write-pointer is adjusted to the slip-pointer value, and data is written to the Reassembly Circular Buffer at the location pointed to by the slip-pointer. The purpose of using the slip-pointer is to establish a known relationship between the read- and write-pointers, to eliminate the possibility of multiple successive slips (e.g., move the write-pointer further away from the read-pointer to prevent underruns occurring over and over).

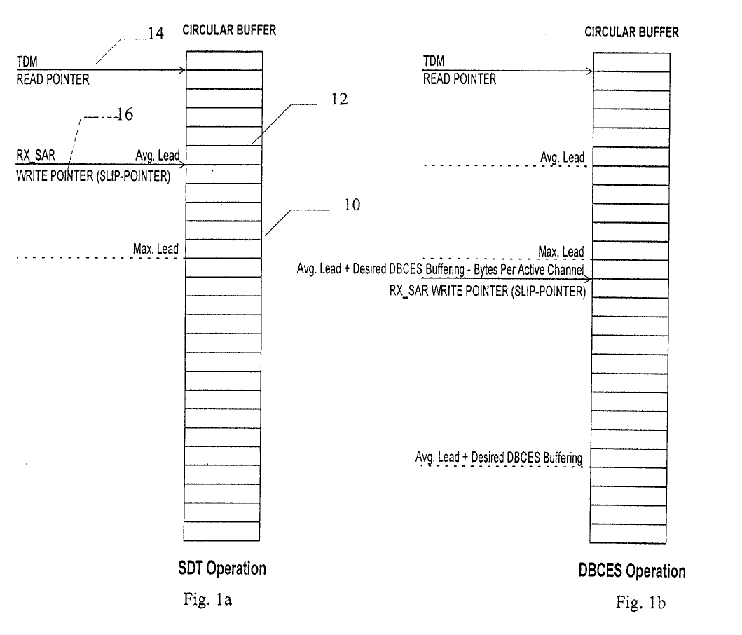

The invention can be implemented in any suitable SAR device. A suitable SAR device, for example, is Mitel's MT90528 device. FIG. 1a illustrates a circular buffer 10 for an RX_SAR in SDT mode of operation. Data is stored at individual addresses 12 in the buffer. Write-pointer 16 determines where the incoming cells are written. Read-pointer 14 determines where the outgoing TDM data is read from.

FIG. 1b shows a similar arrangement for DBCES mode of operation.

Slip-pointer Values in SDT and DBCES Modes of Operation

A predetermined spacing is maintained between the read-pointer and the write-pointer. An explanation of the calculations is given below. The calculations use round-up math.

If the virtual circuit is configured for basic SDT (FIG. 1a), the SDT RX_SAR slip-pointer is assigned to be equal to TDM read-pointer+CDV (CDV is referred to as “avg_lead” and is equal to the user-programmable “Maximum_Lead/2”). CDV represents the cell delay variation with which cells will arrive on the virtual channel at the receiving SAR.

On average, cells should arrive at the SDT RX_SAR at a regular rate (FIG. 1a), so that the cell data will always be written to the circular buffer at time TDM read-pointer+CDV. However, due to cell delay variation, it is possible for cells to arrive more slowly or more quickly than the average. Therefore, enough buffering must be provided in the circular buffers so that if a cell is late arriving, there is enough (previously-received) data in the buffer to ensure that the TDM module can continue reading from the circular buffer at a regular rate, without having underruns occur.

If the virtual channel is configured for DBCES and the DBCES_Control<2> bit is not set, the DBCES version of the SDT RX_SAR slip-pointer is the same as the SDT version of the slip-pointer (i.e., it is equal to TDM read-pointer+CDV) The problem with this situation is that when the number, N, of active channels arriving on a virtual circuit changes, the arrival rate of the cells changes too. For example, in the case of two channels, each cell takes two bytes from each TDM frame, so it takes about 24 frames to fill the payload of a cell. A four-channel VC takes four bytes from each TDM frame, so it only takes 12 frames to fill a cell. In the case of a single channel, only one byte is taken form each frame so it takes a total of 47 TDM frames before a cell is filled and ready to be transmitted.

Assuming that a cell arrives and is written to the circular buffer at the location pointed to by the slip-pointer (i.e., an average distance from the read-pointer), no underruns should occur. However, if the number of active channels on the virtual circuit decreases, it will take a longer amount of time for a cell to be formed at the transmitter. Therefore, the cell arrival rate will decrease. Thus, the TDM module will continue to read from the circular buffer at its regular rate and will underrun, because there will not be enough data in the buffer to permit the TDM module to continue reading until the next cell arrives.

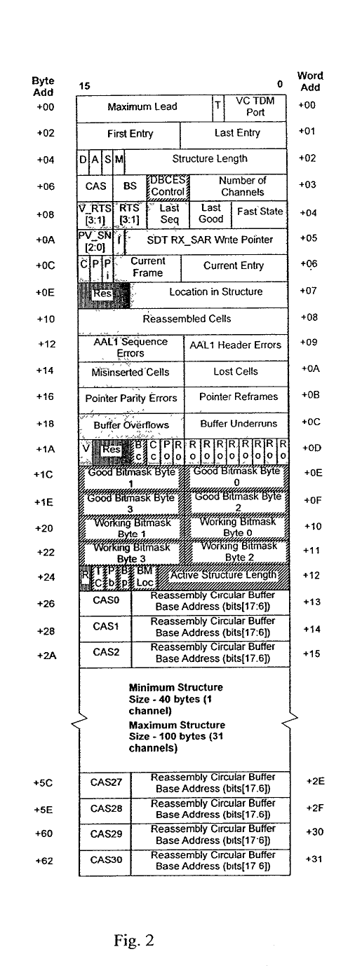

FIG. 2 shows the control structure for the DBCES format. The DBCES Control field determines the amount of buffered data that the user wants to store in each channel's Reassembly Circular Buffer. If set, bit<2> controls whether this variable is used. Bits<1:0> represent the minimum delay buffering desired for each channel: “00”=47 bytes (therefore, the minimum # of active channels in the VC will be 1); “01”=24 bytes (therefore, the minimum # of active channels in the VC will be 2); “10”=16 bytes (therefore, the minimum # of active channels in the VC will be 3): “11”=12 bytes (therefore, the minimum # of active channels in the VC will be 4).

In accordance with the principles of the invention, if the virtual circuit is configured for DBCES and the DBCES_Control<2> bit (see FIG. 2) is set, the SDT RX_SAR write-pointer is assigned to be equal to TDM read-pointer+CDV+active-channel CDV buffer limit for the virtual circuit.

The active-channel buffer limit for the VC is calculated as the number of bytes of DBCES buffering desired by the user (as configured by the setting of the DBCES Control field in the DBCES Reassembly Control Structure for the VC), less the maximum number of bytes which can be written to each SDT Reassembly Circular Buffer for the VC, given the activity profile of the virtual circuit (e.g., if there are 2 active channels in the virtual, a maximum of 24 bytes of data can be written to either circular buffer upon the arrival of a cell).

DBCES Control is used to provide “clean” buffering when the number of active channels in a VC can change by large amounts. When the user sets the DBCES Control field, he or she is defining the minimum number of bytes of buffering which the user wants to always have available in each SDT Reassembly Circular Buffer for the VC. This extra buffering adds delay in terms of the data being output on the TDM bus, but it is useful in preventing buffer underruns when the number of active channels in a VC changes.

A specific example will now be considered.

Assume that the user has determined that the expected CDV between cells on the virtual circuit is 625 μs (five bytes of data in the buffer). As well, the user has decided that he will allow the number of active channels in the virtual circuit to decrease down to a minimum of one (requiring 47 bytes of extra data to be stored in the buffers). Now, let's say that there are four active channels in the virtual circuit to start with. Therefore, using the formula above:

distance from read-pointer=CDV+active-channel buffer limit=5 bytes+(47 bytes−47 bytes/4)=40 bytes

The write-pointer will start writing (upon start-up or an error condition) at a location 40 bytes ahead of the read-pointer. After receipt of a cell, 1/4 of the cell, i.e. 12 bytes, will be added to the buffer so to the write-pointer will then be 52 bytes ahead of the read-pointer.

In the case where a cell with N=1 (i.e. only one channel) is sent, it will take 47 TDM frames for the cell to be assembled at received in the receiver buffer of the RX_SAR. During this time, 47 bytes of data will be read out of the buffer by the read-pointer. Consequently, when the next cell arrives, the write-pointer will still be five bytes ahead of the read-pointer, so no underrun will occur.

distance from read-pointer=CDV=5 bytes+active-channel buffer limit=5 bytes+(47 bytes−47 bytes/1)=5 bytes

However, without DBCES Control, we would have:

distance from read-pointer=CDV=5 bytes.

In this case, if the number of active channels in the virtual circuit drops to one, the TDM module will read out the data stored in the buffer within five frames and then begin reading old data because no new cells will have arrived. Therefore, an underrun would occur.

User programmability of the desired buffering can be provided through the use of a DBCES Control field in each DBCES Reassembly Control Structure, as seen in FIG. 2. The user has the option of either turning this additional buffering on or not, using bit<2> of the DBCES Control field. Bits<1:0> of the DBCES Control field are used to select the amount of additional buffering required in the Reassembly Circular Buffer of each channel within the VC. The options are provided to the user based on the minimum number of active channels that will be carried on the VC. The fewer active channels that will be carried, the greater amount of buffering that will be required, since the cell arrival rate decreases when there are fewer channels in the VC (takes longer to gather enough data to fill a cell). In the example, the user has four options: “00”—minimum of 1 active channel; “01”—minimum of two active channels; “10”=minimum of three active channels; “11”=minimum of four active channels.

Different methods can be used to present or program CDV and MIN (the example allows MIN=1 channel−4 channels and allows CDV=Maximum Lead/2(CDV˜125.s−64 ms). The method can be used in conjunction with an underrun and overrun detection algorithm.

The invention thus provides an effective way of preventing the problem of overruns and underruns that can occur when the number of channels is varied in a DBCES service.

1. A method of managing buffers in a SAR (Segmentation and Reassembly) device operating in DBCES (Dynamic Bandwidth Circuit Emulation Service) mode, comprising:
determining an active channel buffer limit for a virtual circuit dependent on the number of active channels; and
setting the amount of buffering for each active channel equal to the CDV (Cell Delay Variation) plus the active channel buffer limit.

2. A method as claimed in claim 1, wherein each buffer has a write-pointer and a read-pointer, and the distance between the write-pointer and the read-pointer determines the amount of buffering.

3. A method as claimed in claim 1, wherein the active channel buffer limit is equal to the number of bytes of payload data per cell divided by the minimum number of allowable channels less the number of bytes of payload data per cell divided by the number of current active channels.

4. A method as claimed in claim 3, wherein the amount of buffering is recalculated when the number of channels changes so as to provide adequate buffering the next time a change in the number of channels occurs.

5. A method as claimed in claim 4, wherein said method can be activated by setting a control bit in a control structure for the buffers.

6. A method as claimed in claim 4, wherein said buffers are circular buffers.

7. A method as claimed as claimed in claim 1, wherein said DBCES is implemented in an ATM network.

8 A control data structure for a SAR (Segmentation and Reassembly) device capable of implementing DBCES (Dynamic Bandwidth Circuit Emulation Service) mode, comprising:
a control field having a bit determining whether buffer management is active; and
bits determining the minimum buffering for each channel; and wherein
the amount of buffering for each active channel is set equal to the CDV (Cell Delay Variation) less active channel buffer limit, which is dependent on the number of active channels.

9 A control data structure as claimed in claim 8, wherein the active channel buffer limit is equal to the number of bytes of payload data per cell divided by the minimum number of allowable channels less the number of bytes of payload data per cell divided by the number of current active channels.

10. A control data structure as claimed in claim 8, wherein the active channel limit 47/MIN, where MIN is the minimum number of channels N contemplated, minus 47/N, where N is the number of current active channels.
